(19) United States
(12) Patent Application Publication
(10) Pub. No.: US 2025/0138769 A1
(43) Pub. Date: May 1, 2025

(54) DRIVER BOARD AND MULTI-SCREEN DISPLAY DEVICE FOR CONNECTING COMPUTER MULTI-SCREEN DISPLAY

(71) Applicant: Yuan MA, Shenzhen (CN)

(72) Inventor: Yuan MA, Shenzhen (CN)

(21) Appl. No.: 18/383,909

(22) Filed: Oct. 26, 2023

(51) Int. Cl. G06F 3/14; G09G 5/10

(52) U.S. Cl. CPC G06F 3/1438; G06F 3/1446; G09G 5/10; G09G 2300/026; G09G 2320/0626

(57) ABSTRACT

Disclosed in the present invention are a driver board for connecting a computer multi-screen display and a multi-screen display device, the driver board including a main screen splitter and a plurality of auxiliary screen splitters connected with the main screen splitter; the main screen splitter includes a screen splitter mainboard, which is provided with a plurality of output interface terminals corresponding to the plurality of the auxiliary screen splitters; the auxiliary screen splitters include an auxiliary screen mainboard, which is provided with a plurality of input interface terminals corresponding to the output interface terminals, and the input interface terminals and the output interface terminals are connected. With a structure setting of the main screen splitter, screen splitter mainboard, auxiliary screen splitters and auxiliary screen mainboard, the problem that an existing screen splitter display can not display a plurality of program interfaces at the same time is solved.

### TECHNICAL FIELD

The present invention relates to the technical field of screen splitter display, in particular to a driver board for connecting a computer multi-screen display and a multi-screen display device.

### BACKGROUND OF THE INVENTION

With development of society and progress of science and technology, a computer has become an indispensable part of life, wherein application of computing is particularly extensive, and a CPU of the computer and computer performance have obtained larger improvement. In a process of using the computer, it is usually necessary to open a plurality of programs at the same time. For example, it is needed to display pages of the plurality of programs on a screen at the same time in order to implement a content comparison of interfaces of the plurality of programs. It would be inevitable that the display of each page of the plurality of programs is too small when the interfaces of the plurality of the programs appear at the same time on the display of the computer, so the pages can not be clearly viewed at the same time. Meanwhile, when the interfaces of the plurality of programs are switched back and forth for viewing, it is unable to carry out an effective comparison and viewing, which greatly affecting the work efficiency.

A multi-screen display can effectively display the interfaces of the plurality of programs at the same time, which can better provide a user with good working conditions, but the current multi-screen display usually displays by connecting with the computer respectively. Most of the multi-screen displays can only realize screen splitter display of the interfaces of two programs of the computer, but can not realize screen splitter display of interfaces of more programs, so it can not meet the needs of displaying more programs at the same time. In addition, this screen splitter connection requires a plurality of connection wires, and the computer is required to be provided with a plurality of interfaces. In a process of using, as a large number of connection wires would cause confusion in connecting wires, it is not easy to arrange the wires. It would even cause a wrong connection of a wire due to a large number of connection wires.

Therefore, it is necessary to propose a driver board for connecting a computer multi-screen display and a multi-screen display device to improve the above defects.

### BRIEF SUMMARY OF THE INVENTION

In order to overcome the shortcomings in the prior art, the present invention provides a driver board for connecting a computer multi-screen display and a multi-screen display device. The problem that an existing screen splitter display can not display a plurality of program interfaces at the same time is solved to meet the existing needs.

In a first aspect, a technical scheme of the present invention is described as follows:

A driver board for connecting a computer multi-screen display, the driver board comprising a main screen splitter and a plurality of auxiliary screen splitters connected with the main screen splitter, wherein the main screen splitter is used for connecting with a computer, and the auxiliary screen splitters are used for displaying a plurality of windows of the computer respectively;

the main screen splitter comprises a screen splitter mainboard, and the screen splitter mainboard is provided with a plurality of output interface terminals corresponding to the plurality of the auxiliary screen splitters; and

the auxiliary screen splitters comprise an auxiliary screen mainboard, which is provided with a plurality of input interface terminals corresponding to the output interface terminals, and the input interface terminals and the output interface terminals are connected, and are used for transmitting data.

In a possible implementation, the driver board comprises two main screen splitters;

the plurality of the output interface terminals comprise two first-level interfaces, and the first-level interfaces are connected with the main screen splitters, and the first-level interfaces are used for transmitting a control instruction and display data.

In a possible implementation, the driver board comprises two auxiliary screen splitters;

the plurality of the output interface terminals comprise two second-level interfaces, and the second-level interfaces are connected with the auxiliary screen splitters, and the second-level interfaces are used for transmitting display data. In a possible implementation, the screen splitter mainboard is also

provided with a charging interface terminal and a computer interface terminal, the charging interface terminal is used to connect a power supply, and the computer interface terminal is used to connect the computer.

In a possible implementation, the auxiliary screen mainboard is provided with an external data interface terminal, which is used for transmitting video data.

In a possible implementation, the auxiliary screen mainboard is provided with a first brightness adjusting terminal and a second brightness adjusting terminal, the first brightness adjusting terminal is used to increase screen brightness, and the second brightness adjusting terminal is used to reduce the screen brightness.

In a possible implementation, the auxiliary screen mainboard is also provided with a screen-off adjusting terminal, which is used to switch between a sleep mode and an awake mode of an auxiliary screen.

In a second aspect, the present invention also provides a multi-screen display device, wherein the multi-screen display device comprises the driver board for connecting a computer multi-screen display according to any one of claims 1-7.

According to the above technical schemes of the present invention, the present invention has the beneficial effects as follows: a driver board for connecting a computer multi-screen display and a multi-screen display device, comprising a main screen splitter, a screen splitter mainboard, auxiliary screen splitters and an auxiliary screen mainboard, wherein, with a structure setting of the main screen splitter, screen splitter mainboard, auxiliary screen splitters and auxiliary screen mainboard, the present invention can display at least two interfaces of programs in the computer on the main screen splitter and the auxiliary screen splitters. In addition, with the structure setting of the auxiliary mainboard and the screen splitter mainboard, the connection relationship between the auxiliary screen splitters and the main screen splitter can be effectively planned, which solves the problem that the plurality of connection wires can not be effectively put in order and effectively avoids the problem that the connection wires are wrongly connected at the same time.

### BRIEF DESCRIPTION OF THE DRAWINGS

FIG. 1 is a schematic diagram of a working principle of the present invention;

FIG. 2 is a block diagram of a circuit structure of a screen splitter mainboard in this embodiment; and

FIG. 3 is a block diagram of a circuit structure of an auxiliary screen mainboard in this embodiment.

In the figures:

10. main screen splitter; 11. screen splitter mainboard; 111. charging interface terminal; 112. computer interface terminal; 12. output interface terminal; 121. first-level interface; 122. second-level interface; 20. auxiliary screen splitter; 21. auxiliary screen mainboard; 211. external data interface terminal; 212. first brightness adjusting terminal; 213. second brightness adjusting terminal; 214. screen-off adjusting terminal; 22. input interface terminal; 23. first-level screen splitter; 24. second-level screen splitter.

### DETAILED DESCRIPTION OF THE INVENTION

The present invention is further described in combination with the attached drawings and implementation below:

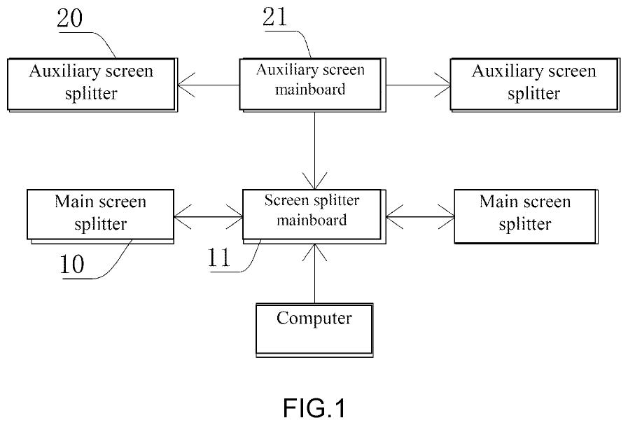

As shown in FIG. 1 to FIG. 3, disclosed in the present invention are a driver board for connecting a computer multi-screen display, the driver board comprising main screen splitters 10 and auxiliary screen splitters 20 connected with the main screen splitters 10, and main screen splitters 10 are used to be electrically connected with a computer and are also used to process data sent from the computer to the main screen splitters 10 so as to transmit the processed data to a plurality of auxiliary screen splitters 20; the auxiliary screen splitters 20 are used to display a plurality of display interfaces of programs on the computer, wherein the main screen splitters 10 comprise a screen splitter mainboard 11, which is provided with a plurality of output interface terminals 12 corresponding to the auxiliary screen splitters 20; in addition, the auxiliary screen splitters 20 comprise auxiliary screen mainboards 21, which is provided with input interface terminals 22 corresponding to the output interface terminals 12, and the input interface terminals 22 and the output interface terminals 12 are electrically connected, and are used for transmitting data.

In this embodiment, the computer and the main screen splitters 10 are connected, and display data of the plurality of programs is transmitted to the screen splitter mainboard 11 through the output interface terminals 12, wherein the screen splitter mainboard 11 is connected to the main screen splitters 10 respectively, and the main screen splitters display part of the data sent to the screen splitter mainboard 11; and the other part of the data is processed and analyzed by the screen splitter mainboard 11 and sent to the plurality of auxiliary screen mainboards 21 through the input interface terminals 22, and is displayed by the auxiliary screen splitters 20. With the structure setting of the main screen splitters 10, screen splitter mainboard 11, auxiliary screen splitters 20 and auxiliary screen mainboards 21, the present invention can display at least two interfaces of programs in the computer on the main screen splitters 10 and the auxiliary screen splitters 20. In addition, with the structure setting of the auxiliary screen mainboards 21 and the screen splitter mainboard 11, the connection relationship between the auxiliary screen splitters 20 and the main screen splitters 10 can be effectively planned, which solves the problem that the plurality of connection wires can not be effectively put in order and effectively avoids the problem that the connection wires are wrongly connected at the same time.

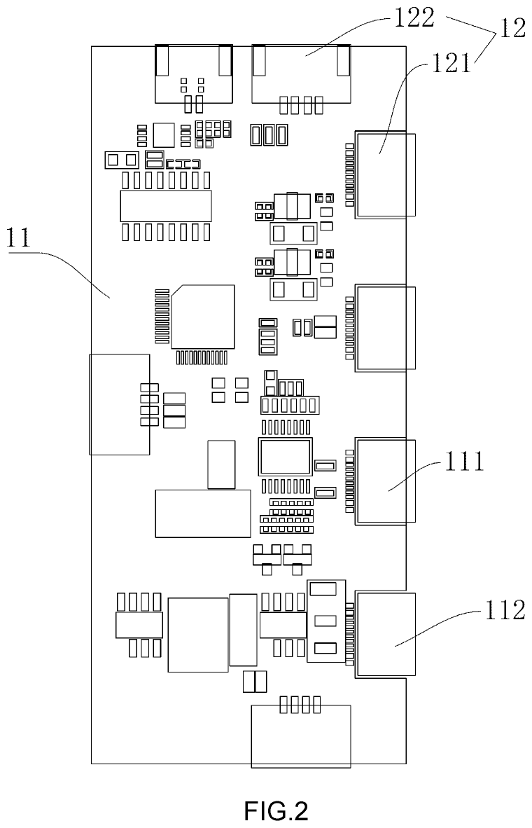

Further, refer to FIG. 1 and FIG. 2, the driver board comprises two main screen splitters 10, the plurality of the output interface terminals 12 comprise two first-level interfaces 121, and the first-level interfaces and the main screen splitters 10 are connected, and the first-level interfaces 121 are used for transmitting a control instruction and display data.

In this embodiment, the driver board comprises two main screen splitters 10, and the two main screen splitters 10 are respectively connected to the screen splitter mainboard 11, wherein the plurality of transmission interface terminals comprise two first-level interfaces 121, and the two main screen splitters 10 are respectively connected through two first-level interfaces 121, and the first-level interfaces 121 are used for transmitting the control instruction and display data. Thus, the screen splitter mainboard 11 and the computer are connected, and the two main screen splitters 10 are both connected to the screen splitter mainboard 11, which reduces the connection wire between the screen splitters and the computer, and is more convenient to put the connection wires in order.

Further, refer to FIG. 1 to FIG. 3, the driver board comprises two auxiliary screen splitters 20; the plurality of output interface terminals 12 further comprise two second-level interfaces 122, and the second-level interfaces 122 are connected with the auxiliary screen splitters 20, and the second-level interfaces 122 are used for transmitting display data.

In this embodiment, the driver board further comprises two auxiliary screen splitters 20, and the two auxiliary screen splitters 20 are electrically connected to the screen splitter mainboard 11 through the auxiliary screen mainboards 21, wherein the plurality of output interface terminals further comprises two second-level interfaces 122, and the screen splitter mainboard 11 is connected to the auxiliary screen mainboard 21 through two earphone interfaces, and the two second-level interfaces 121 are used for transmitting display data, so that the screen splitter mainboard 11 and the auxiliary screen splitters 20 are connected and the auxiliary screen splitters 20 display the display data. With the structure setting of the two auxiliary screen splitters 20 and the two second-level interfaces 122, the two auxiliary screen splitters 20 can display interfaces of at least two computer programs so as to implement screen splitting.

Further, refer to FIG. 1 and FIG. 2, the screen splitter mainboard 11 is also provided with a charging interface terminal 111 and a computer interface terminal 112, the charging interface terminal 111 is used to connect a power supply, and the computer interface terminal 112 is used to connect the computer.

In this embodiment, the screen splitter mainboard 11 is also provided with the charging terminal and the computer interface terminal 112. The charging interface terminal 111 is used to connect the power supply so that the power supply supplies power to the screen splitter mainboard 11, and the computer interface terminal 112 is used to connect the computer. Specifically, the data of the plurality of computer programs is sent from the computer to the screen splitter mainboard 11 through the computer interface terminal for analysis and processing of the screen splitter mainboard 11.

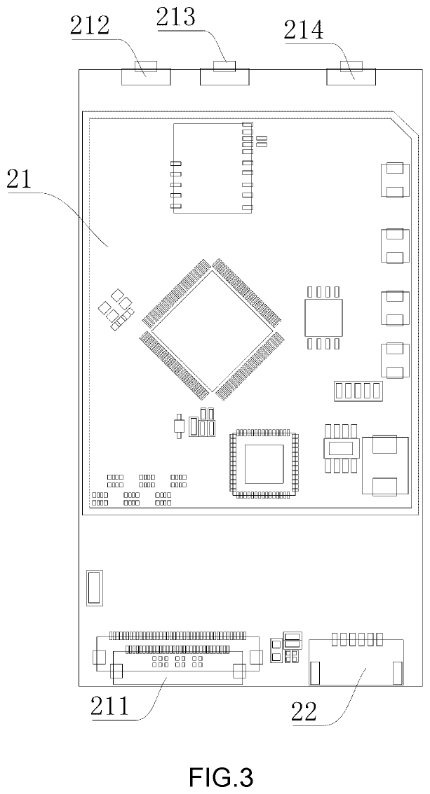

Further, refer to FIG. 3, the auxiliary screen mainboard 21 is provided with an external data interface terminal 211, which is used for transmitting video display data.

In this embodiment, the external data interface terminal 211 may be an LVDS interface or an EDP interface, enabling the auxiliary mainboard to display the interface of the computer program and other data.

Further, refer to FIG. 3, the auxiliary screen mainboard 21 is provided with a first brightness adjusting terminal 212 and a second brightness adjusting terminal 213, the first brightness adjusting terminal 212 is used to increase screen brightness of the screen splitter, and the second brightness adjusting terminal 213 is used to reduce the screen brightness of the screen splitters.

In this embodiment, the first brightness adjusting terminal 212 and the second brightness adjusting terminal 213 are provided on one side of the auxiliary screen mainboard 21, and with the structure setting of the first brightness adjusting terminal 212 and the second brightness adjusting terminal 213, the brightness of the auxiliary screen splitters 20 can be adjusted, which improves the humanization of the present invention.

Further, refer to FIG. 3, the auxiliary screen mainboard 21 is also provided with a screen-off adjusting terminal 214, which is used to switch between a sleep mode and an awake mode of an auxiliary screen.

In this embodiment, one side of the auxiliary screen mainboard 21 is also provided with the screen-off adjusting terminal 214, and the screen-off adjusting terminal 214 is located below the second brightness adjusting terminal 213. With the structure setting of the screen-off adjusting terminal 214, the auxiliary screen splitters 20 can be better adjusted for screen-on time, avoiding the possibility of heavy power consumption, and thus improving the environmental protection performance of the present invention.

It should be understood that, for a person of ordinary skill in the art, improvements or transformations may be made in accordance with the above description, and that all such improvements and transformations shall fall within the protection scope of the attached claims in the present invention.

An illustrative description of the present application is given above in combination with the attached drawings. It is clear that the realization of the present application is not limited by the above method. various improvements adopting the method concept and technical scheme of the present application, or those for which the concept and technical scheme of the present application are directly applied to other occasions without improvement are within the protection scope of the present invention.

What is claimed is:

1. A driver board for connecting a computer multi-screen display, the driver board comprising a main screen splitter (10) and a plurality of auxiliary screen splitters (20) connected with the main screen splitter (10), wherein the main screen splitter (10) is used for connecting with a computer, and the auxiliary screen splitters (20) are used for displaying a plurality of windows of the computer respectively;
the main screen splitter (10) comprises a screen splitter mainboard (11), and the screen splitter mainboard (11) is provided with a plurality of output interface terminals (12) corresponding to the plurality of the auxiliary screen splitters (20); and
the auxiliary screen splitters (20) comprise an auxiliary screen mainboard (21), which is provided with a plurality of input interface terminals (22) corresponding to the output interface terminals (12), and the input interface terminals (22) and the output interface terminals (12) are connected, and are used for transmitting data.

2. The driver board for connecting a computer multi-screen display according to claim 1, wherein the driver board comprises two main screen splitters (10);
the plurality of the output interface terminals (12) comprise two first-level interfaces (121), and the first-level interfaces (121) are connected with the main screen splitters (10), and the first-level interfaces (121) are used for transmitting a control instruction and display data.

3. The driver board for connecting a computer multi-screen display according to claim 2, wherein the driver board comprises two auxiliary screen splitters (20);
the plurality of the output interface terminals (12) comprise two second-level interfaces (122), and the second-level interfaces (122) are connected with the auxiliary screen splitters (20), and the second-level interfaces (122) are used for transmitting display data.

4. The driver board for connecting a computer multi-screen display according to claim 3, wherein the screen splitter mainboard (11) is also provided with a charging interface terminal (111) and a computer interface terminal (112), the charging interface terminal (111) is used to connect a power supply, and the computer interface terminal (112) is used to connect the computer.

5. The driver board for connecting a computer multi-screen display according to claim 1, wherein the auxiliary screen mainboard (21) is provided with an external data interface terminal (211), which is used for transmitting video data.

6. The driver board for connecting a computer multi-screen display according to claim 5, wherein the auxiliary screen mainboard (21) is provided with a first brightness adjusting terminal (212) and a second brightness adjusting terminal (213), the first brightness adjusting terminal (212) is used to increase screen brightness, and the second brightness adjusting terminal (213) is used to reduce the screen brightness.

7. The driver board for connecting a computer multi-screen display according to claim 6, wherein the auxiliary screen mainboard (21) is also provided with a screen-off adjusting terminal (214), which is used to switch between a sleep mode and an awake mode of an auxiliary screen.

8. The driver board for connecting a computer multi-screen display according to claim 4, wherein the auxiliary screen mainboard (21) is provided with an external data interface terminal (211), which is used for transmitting video data.

9. The driver board for connecting a computer multi-screen display according to claim 8, wherein the auxiliary screen mainboard (21) is provided with a first brightness adjusting terminal (212) and a second brightness adjusting terminal (213), the first brightness adjusting terminal (212) is used to increase screen brightness, and the second brightness adjusting terminal (213) is used to reduce the screen brightness.

10. The driver board for connecting a computer multi-screen display according to claim 9, wherein the auxiliary screen mainboard (21) is also provided with a screen-off adjusting terminal (214), which is used to switch between a sleep mode and an awake mode of an auxiliary screen.

11. A multi-screen display device, wherein the multi-screen display device comprises the driver board for connecting a computer multi-screen display according to claim 1.

12. A multi-screen display device, wherein the multi-screen display device comprises the driver board for connecting a computer multi-screen display according to claim 4.
